(19) United States
(12) Patent Application Publication
(10) Pub. No.: US 2012/0090700 A1
(43) Pub. Date: Apr. 19, 2012

(54) PIPING SUPPORT, SYSTEM, AND METHOD FOR USE

(75) Inventors: Thomas Multer, Liberty, SC (US); John Tow, Liberty, SC (US)

(73) Assignee: THE RELIABLE AUTOMATIC SPRINKLER CO., INC., Liberty, SC (US)

(21) Appl. No.: 12/907,890

(22) Filed: Oct. 19, 2010

(51) Int. Cl. F16L 3/00; F16L 5/00

(52) U.S. Cl. 137/357; 285/64

(57) ABSTRACT

A fluid distribution system is provided including a fluid supply, at least one conduit in fluid communication with the fluid supply, and at least one mountable fitting fluidly coupled to the conduit. The mountable fitting includes a body and a mounting base. The body defines a cavity having a plurality of ports in fluid communication with the cavity and the conduit, at least one port of the plurality of ports having a connection portion configured to fluidly couple to at least the fluid conduit. The mounting base extends a fixed distance from the body configured to be mounted to a structure to space the body a fixed distance from the structure.

### BACKGROUND OF THE INVENTION

### Field of the Invention

Conventional sprinkler systems can include a fluid supply network comprising a plurality of interconnected conduits (i.e., pipes) rigidly supported at or above the ceiling, connected to other conduits, fittings, manifolds, valves, and sprinklers in ceilings and walls. The fluid supply network is conventionally located in walls and ceilings of an occupancy to be protected so that sprinklers, such as sidewall, upright, and pendent sprinklers can be fluidly connected thereto.

Conventionally, pipes making up the piping network are supported using pipe hangers that are fastened to the building structure, such as ceiling joists and wall studs. One example of a conventional pipe hanging system is Cooper B-Line® Pipe Hangers and Supports, manufactured by Cooper B-Line®, Inc. of Highland, Ill. The B-Line® pipe hangers permit the pipe to pass through a pair of semicircular flanges which clamp around the outer surface of the pipe by applying a frictional clamping force with fasteners, while the clamp/pipe assembly is fastened to the building structure. In such cases the pipe hanger forms no part of the fluid handling system, as no part of the hanger is a wetted surface, and functions merely to support the piping structurally. Other conventional piping support arrangements include pipe guides, pipe saddles, and pipe roller supports. Moreover, in cases where piping is run between floors and within the framing of walls, installers may bore holes in wall studs and flooring to permit the piping to pass therethrough. Such hole boring is labor intensive and costly.

Moreover, conventional pipe fittings, including pipe elbows, tees, and reducing bushings, are not readily fastened to the building structure to support the piping they are joining.

Sprinklers are further connected to the piping network at various locations and are usually installed on-site after the piping is installed. The sprinklers are conventionally connected to the piping network by threading each sprinkler onto a mating fitting in fluid communication with the piping network. Often, the sprinkler is installed with a special sprinkler wrench which aids in installing the sprinkler without breaking the heat sensitive sprinkler actuation mechanism need to activate the sprinkler during a fire condition. Moreover, due to space limitations pipe installers must approximate a sufficient amount of space around fittings in the piping network so that sprinklers can be installed with appropriate tools.

Frequently, PVC and CPVC materials are used for piping and pipe fittings for sprinkler piping networks. However, most sprinklers have threaded bodies that are formed from metals, including brass and stainless steel. In order to connect metal-bodied sprinklers having threaded connectors to PVC and CPVC piping, adapters are conventionally used. One typical example relies on bonding a threaded female PVC or CPVC adapter to the outer surface of the PVC or CPVC piping which can receive a male threaded connector of a sprinkler. The bonding agent is typically a suitable pipe cement that forms a permanent connection between the adapter and the pipe. Care must be taken by the installer not to overtighten the sprinkler threads in the PVC or CPVC fitting, which could cause such adapter fittings to crack, requiring further labor, material, and time expense to repair the damage.

In addition, in the case of residential and commercial sprinkler installations, sprinklers must be connected to the piping network such that when wallboard covers the piping and wall structure the installed sprinkler will be at a desired distance from the surface of the wallboard. In addition, design changes may occur after the installation of the piping network requiring alterations in the thicknesses of wallboard which are not usually accounted for in the layout of the piping network.

One attempted solution to the foregoing problems is the FIREPEX® Residential Fire Protection System by REHAU. The REHAU system uses an EVERLOC® model tee fitting to connect conduits of the piping network and sprinklers together. The EVERLOC fitting can be affixed to the structure of a building. Flexible tubing is terminated with mating EVERLOC fittings are connected to mating connectors of the EVERLOC tee fittings and are connected with a snap fit connection. A fire protection sprinkler is also connected to one of the ports of the tee fitting.

### SUMMARY

In a first aspect, the present inventors have provided a fluid distribution system including a fluid supply, at least one conduit in fluid communication with the fluid supply, and at least one mountable fitting fluidly coupled to the conduit. The mountable fitting includes a body and a mounting base. The body defines a cavity having a plurality of ports in fluid communication with the cavity and the conduit, at least one port of the plurality of ports having a connection portion configured to fluidly couple to at least the fluid conduit. The mounting base extends a fixed distance from the body configured to be mounted to a structure to space the body a fixed distance from the structure.

In another aspect the inventors have provided a fitting that comprises a body and a mounting base. The body defines a cavity having a plurality of ports in fluid communication with the cavity, at least one port of the plurality of ports having a connection portion configured to fluidly couple to at least a conduit. The mounting base extending a fixed distance from the body configured to be mounted to a structure to space the body a fixed distance from the structure.

The fitting may be formed of brass, acetyl copolymer, stainless steel, copper, iron, CPVC, nylon, and PVC. The fitting may include two, three, and four ports.

### BRIEF DESCRIPTION OF THE DRAWINGS

FIG. 1 shows a perspective view of an embodiment of a fitting in accordance with an aspect of the invention shown in fluid communication with a portion of a fluid distribution system and a recessed fire protection sprinkler.

FIG. 1A shows a perspective view of another embodiment of a fitting in accordance with an aspect of the invention shown in fluid communication with a portion of a fluid distribution system and a concealed fire protection sprinkler.

FIG. 2 shows an exploded assembly of the fitting shown in FIG. 1.

FIG. 2A shows an exploded assembly of the fitting shown in FIG. 1A.

FIG. 3 shows a sectional view from section A-A shown in FIG. 1.

FIG. 4 shows a sectional view from section B-B shown in FIG. 1.

FIG. 4A shows an enlarged view of the dotted-line box in FIG. 4.

FIG. 5 shows a perspective view of another embodiment of a fitting in accordance with an aspect of the invention shown in fluid communication with a pair of sidewall fire protection sprinklers.

FIG. 6 shows a sectional view from section 6-6 shown in FIG. 5.

FIG. 7 shows a sectional view from section 7-7 shown in FIG. 5.

FIG. 8 shows a plan view of the fitting shown in FIG. 5.

FIG. 9 shows a sectional view of another embodiment of a fitting in accordance with an aspect of the invention shown in fluid communication with a pair of sidewall fire protection sprinklers.

In the discussion that follows, like reference numbers correspond to like elements.

### DETAILED DESCRIPTION

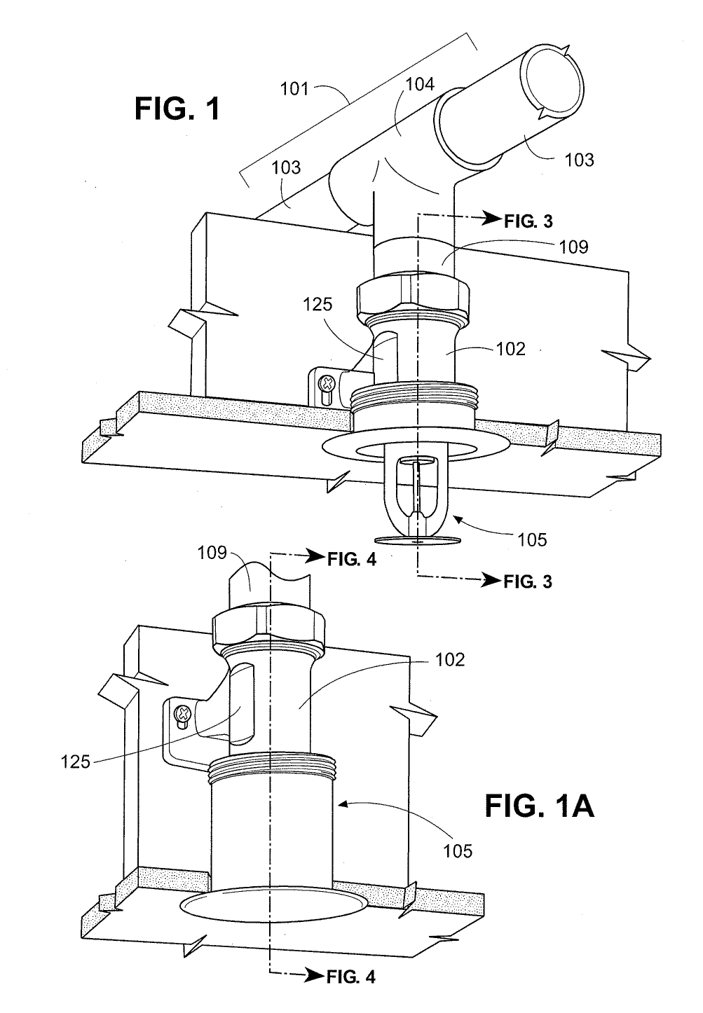

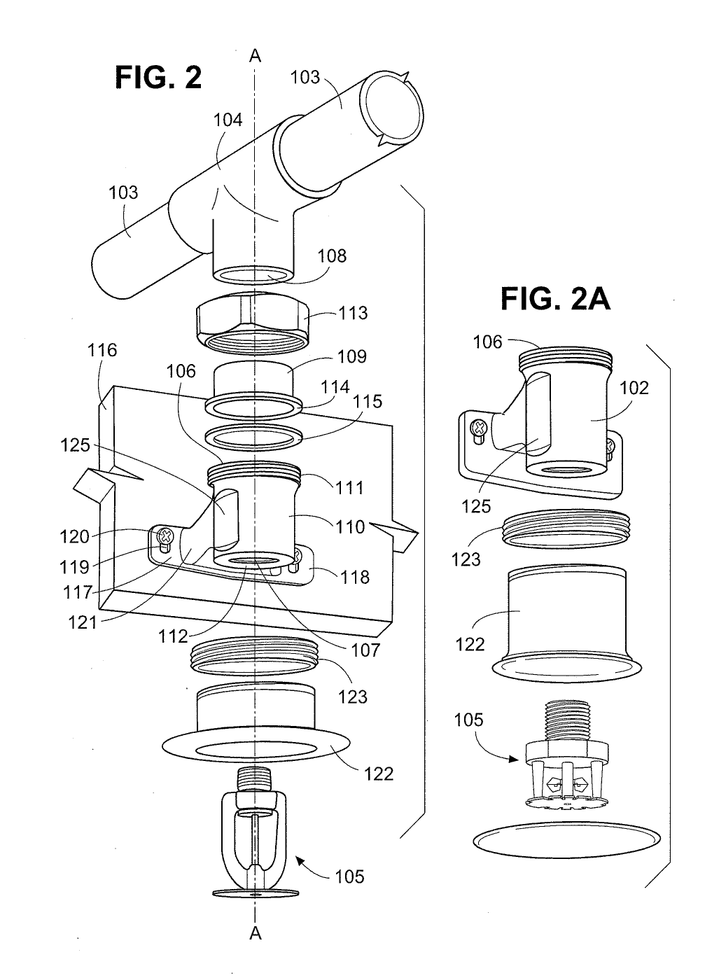

A first embodiment of a mountable fitting is shown as part of a sprinkler system in accordance with an aspect of the invention in FIG. 1. A portion of a representative piping network 101 is configured to carry a fire retardant, such as, for example, water, and is connected to at least one mountable fitting 102 via a tailpiece 109. The mountable fitting 102 has a plurality of ports 106, 107 (FIG. 2) in communication with each other, as will be discussed in further detail below. The portion of the piping network 101 shown in partial perspective view includes fluid conduits 103 in fluid communication with a fluid supply, such as a water supply main of a building. Such fluid conduits 103 may be formed from rigid, semi-rigid, flexible, and semi-flexible materials including copper, cast iron, stainless steel, brass, PVC, CPVC, and PEX. The fluid conduits 103 are configured to be fluid coupled to other fluid conduits 103 with suitable fluid connectors 104 configured and formed from material(s) adapted to be used in conjunction with that (those) of the conduits 103. The fluid conduits 103, fitting 104, tailpiece 109, and mountable fitting 102 are preferably configured to deliver fire retardant to at least one fire protection sprinkler 105 that is in fluid communication therewith. The mountable fitting 102 is mounted to a structure by virtue of a mounting base 117.

FIG. 1 shows an embodiment of the mountable fitting 102 in fluid communication with a sprinkler 105 configured as a recessed pendent fire protection sprinkler, while in an alternative embodiment shown in FIG. 1A, the sprinkler 105 is configured as a concealed pendent fire protection sprinkler.

FIG. 2 shows an exploded assembly drawing of the mountable fitting 102, sprinkler 105, tailpiece 109, and piping network 101 shown in FIG. 1. The mountable fitting 102 has two ports 106 and 107 that are preferably substantially in axial alignment with one another. The connector 104 includes at least one port 108 adapted to be connected to the tailpiece 109, which in one embodiment, is configured as a Pipe Master™ tailpiece manufactured by Conbraco Industries, Inc., of Matthews, N.C. In such an example embodiment, the connector 104, the conduits 103, and the tailpiece 109 are formed of PVC or CPVC and connected using conventional pipe fitting techniques for such materials as would be appreciated by one of skill in the art, such as pipe cement.

The mountable fitting 102 includes a body 110 in fluid communication with the first port 106 and the second port 107. The body 110 of the fitting 102 may have at least one flat portion 125 on its outer surface, and more preferably may have at least two flat portions 125. Such flat portions 125 may be configured to be used in conjunction with a tool, such as a wrench, to secure the fitting during connection of the sprinkler 105 and/or connecting the first connection portion 111 to the tailpiece 109 while turning a nut 113 to engage threads on the first connection portion 111.

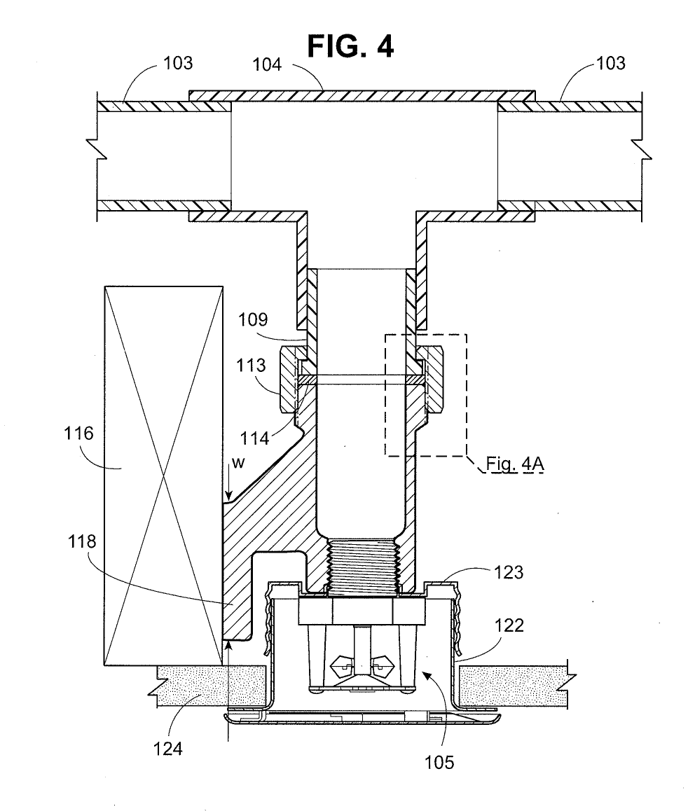

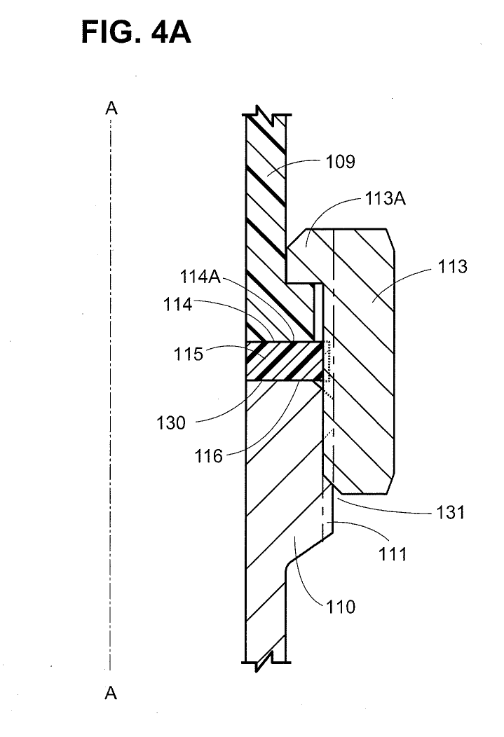

The first port 106 is configured to connect to the tailpiece 109 and the second port 107 is configured to connect to the sprinkler 105. The first port 106 includes a first connection portion 111 configured as a threaded connection. The threads of the first connection portion 111 are configured to engage with mating threads of the nut 113. In one embodiment, the threads of the first connection portion 111 includes a set of male unified fine thread (UNF) threads for engaging with a set of female UNF threads on the inner annular surface of the nut 113. The tailpiece 109 has an annular sealing flange 114 having a sealing face configured to seal against an annular sealing gasket 115. The gasket 115 can be formed from various seal materials, including rubber, EPDM, silicone, and buna-n. The tailpiece 109, gasket 115, and first connection portion 111 can be compressed and sealed together by virtue of the engagement of the complimentary threaded portions of the first connection portion 111 and the nut 113 and the annular sealing flange 114 and a complimentary annular sealing flange 130 (FIG. 4A) formed in the first connection portion 111.

The second port 107 includes a second connection portion 112 having a threaded connection configured to engage mating threads of a threaded connection of the sprinkler 105 to fluidly couple the sprinkler 105 to the fitting 102. In one embodiment, the second connection portion 112 may include a set of female national pipe threads (NPT) for engagement with a set of male NPT threads of the sprinkler 105. The sprinkler 105 is shown configured as a recessed pendent sprinkler, such as the model F1 residential FP sprinkler manufactured by The Reliable Automatic Sprinkler Company, Inc. The recessed sprinkler 105 preferably includes an escutcheon 122 which is connected to a cup 123 that is threaded onto the threads of the sprinkler 105. The cup 123 is configured to receive the escutcheon 122 and retain the escutcheon 122 in contact with the lower surface of the ceiling board 124. Preferably, the escutcheon 122 and cup 123 are configured to be connected in such a manner that there is some adjustability of movement to account for variations in the mounting distance of the fitting 102 with respect to the ceiling.

The mountable fitting 102 also includes at least one pedestal 117 or base extending from the body 110 configured to be mounted to a portion of a structure 116, such as, for example, a wall stud or ceiling joist of a building. The pedestal 117 includes a mounting flange 118 and an extension portion 121 between the body 110 and the mounting flange 118. The mounting flange 118 has a length “L” that extends in a direction that is substantially transverse to the axis A-A of the fitting body 110. In one embodiment the length L of the mounting flange 118 is larger than the outer diameter of the portion of the body 110 laterally across from the mounting flange 118. As shown in the embodiment shown in FIG. 2, apertures 119 formed in the mounting flange 118 straddle the body 110 so that a tool, such as, for example, a screwdriver, can access a fastener 120 at an angle that is substantially perpendicular to the flange 118. For example, the mounting flange 118 can be mounted to a wood floor joist with a wood screw 120. The aperture 119 may be configured as an elongated slot, such as in the vertical direction, to provide vertical mounting height adjustment of the fitting 102 with respect to the structure 116. The mounting flange 118 has a width “w” that extends substantially perpendicular to its length L. The mounting flange 118 has a planar mounting surface configured to contact at least a portion of the structure 116 when the fitting 102 is mounted thereto.

FIG. 2A shows an alternative embodiment of the arrangement shown in FIG. 2 with the recessed pendent sprinkler 105 replaced by a concealed pendent sprinkler. Such a concealed pendent sprinkler may be configured, for example, as a model RFC 43 or RFC 49 residential flat concealed sprinkler, manufactured by The Reliable Automatic Sprinkler Company, Inc. The concealed sprinkler 105 shown in FIG. 2A is preferably connected to the escutcheon 122 and cup 123 in the same manner as that of the recessed pendent sprinkler 105 shown in FIG. 2.

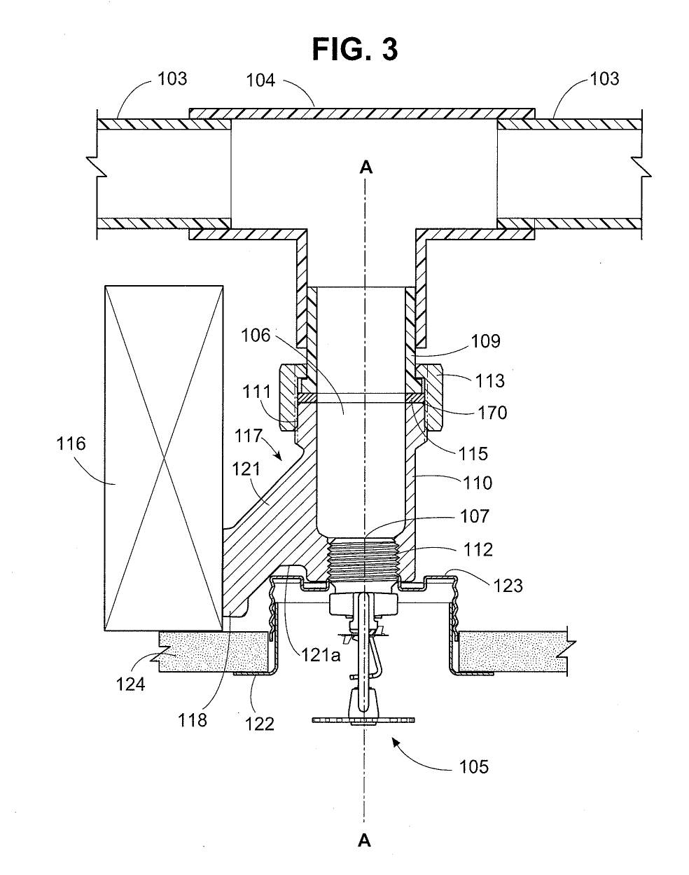

The pedestal 117 is configured to dispose the body 110 of the fluid connection portions 111 and 112 at a certain fixed distance and orientation with respect to the building structure 116, as shown in FIG. 2 and in greater detail in FIGS. 3 and 4. In one example, the pedestal 117 is preferably configured to space the connection portions 111 and 112 a certain minimum distance from the structure 116 to provide sufficient clearance to facilitate the application of a tool, such as a wrench, to either the nut 113 or the wrench boss of the sprinkler 105 to make the respective fluid connections.

As shown in FIGS. 3 and 4, the extension portion 121 extends a certain distance from the body 110 to the mounting flange 118 in a direction that is substantially transverse to the axis A-A through the body 110. The thickness of the mounting flange 118 and the length of the extension portion 121 are predetermined to preferably dispose the first and second connection portions, 111 and 112, respectively, at least a certain distance from the surface of the structure 116. Such clearance can be used for placement of a tool, such as a wrench to connect the nut 113 and the sprinkler 105 to the fitting 102.

The pedestal 117 may have alternate mounting configurations to account for various sprinklers 105 connected to the fitting 102 and space limitations between the piping network 101 and the ceiling 124, for example. For example, in the embodiment shown in FIGS. 1, 2, and 3, the pedestal 117 and the fitting 102 are configured for connecting to a sprinkler 105 configured as a recessed pendent sprinkler, whereas in the embodiment shown in FIGS. 1A, 2A, and 4, the pedestal 117 is configured for connecting to a sprinkler 105 configured as a concealed pendent sprinkler.

FIG. 3 shows a partial section cutaway view of a ceiling 124 above which the piping network 101 and fitting 102 of FIG. 1 is installed and through which the sprinkler 105 extends.

The extension portion 121 is preferably formed as a gusset between the mounting flange 118 and the body 110 of the fitting 102. The extension portion 121 extends in a plane through the axis of the body 110, laterally between the mounting flange 118 and the body 110 and tapers vertically upwards from the mounting flange 118 towards the first connection portion 111 on the outer surface of the body 110.

The extension portion 121 includes a notch 121a at its lower surface which is preferably configured to accommodate a portion of the cup 123 which extends vertically upward beyond the lower surface of the second port 107.

Similar to the arrangement shown in FIG. 3, FIG. 4 shows an arrangement of an embodiment of the fitting 102 connected to the piping network 101 that is configured to connect to a sprinkler 105 configured as a concealed pendent sprinkler, such as an RFC 43 or RFC 49 residential flat concealed sprinkler, manufactured by The Reliable Automatic Sprinkler Company, Inc. This embodiment differs from the embodiment shown in FIG. 3 in that the width w of the mounting flange 118 is shown as being larger in FIG. 4. The wider mounting base 118 can be configured to dispose the second connection portion 112 further away from the ceiling board 124, than the mounting base 118 in FIGS. 1-3, when the lower edge of the respective mounting bases 118 are disposed at the same positions on the structure 116, for example. The larger width w of the mounting flange 118 in the embodiment shown in FIG. 4 is preferably configured to accommodate the cup 123, which is shown extending upwards further from the upper surface of the ceiling board 124 than the cup 123 shown in FIG. 3. While not shown in FIG. 4, apertures are also formed in the mounting flange 118 of the embodiment shown in FIG. 4, and are preferably formed as elongated slots which may be longer than the apertures formed in the mounting flange 118 of the first embodiment shown in FIGS. 1, 2, and 3.

FIG. 4A shows an exploded view of an example of the connection between the tailpiece 109 and the first connection portion 111. The nut 113 has an inner annular flange 113a at a first open end which engages the flange 114 of the tailpiece. The gasket 115 is disposed between, and in contact with, the annular face of the flange 114 and the annular surface 130 of the end of the first port 106. The flange 114 and the annular surface 130 are compressed against the gasket 115 by threading the nut 113 onto the threads of the first connection portion 111. In one embodiment the gasket 115 has an inner diameter that is coextensive with the inner diameter of the tailpiece flange 114.

In one embodiment, the nut 113 is configured to retain the gasket 115 by virtue of an interference fit between the outer diameter of the gasket 115 and the inner annular diameter of the surface of the nut 113. For example, in such an embodiment the outer diameter of the gasket 115 may be configured to be slightly larger than the diameter of the inner annular surface of the nut 113, such that the gasket 115 will be retained with the nut 113 by virtue of insertion of the gasket 115 into a second end 131 of the nut 113. By virtue of such a captured gasket 115, the nut 113, gasket 115, and tailpiece 109 can be assembled together as a subassembly so that the tailpiece 109 is retained between the flange 113a of the nut 113 and the gasket 115. Such a captured tailpiece 105/gasket 115/nut 113 assembly, hereinafter referred to as a “tailpiece subassembly”, can reduce part handling during installation of the subassembly. Moreover, such the tailpiece subassembly may prevent an installer from omitting or misplacing the gasket 115 during installation. For example, where the tailpiece subassembly is already connected to the piping network 101, the subsequent installation of the fitting 102 or a fitting 102/sprinkler 105 subassembly, hereinafter referred to as a “sprinkler subassembly”, to the tailpiece 109 can be facilitated by simply threading the nut 113 onto the threads of the first connection portion 111 of the fitting 102. Other features and benefits of such a subassembly will become apparent to one of skill in the art in view of this disclosure.

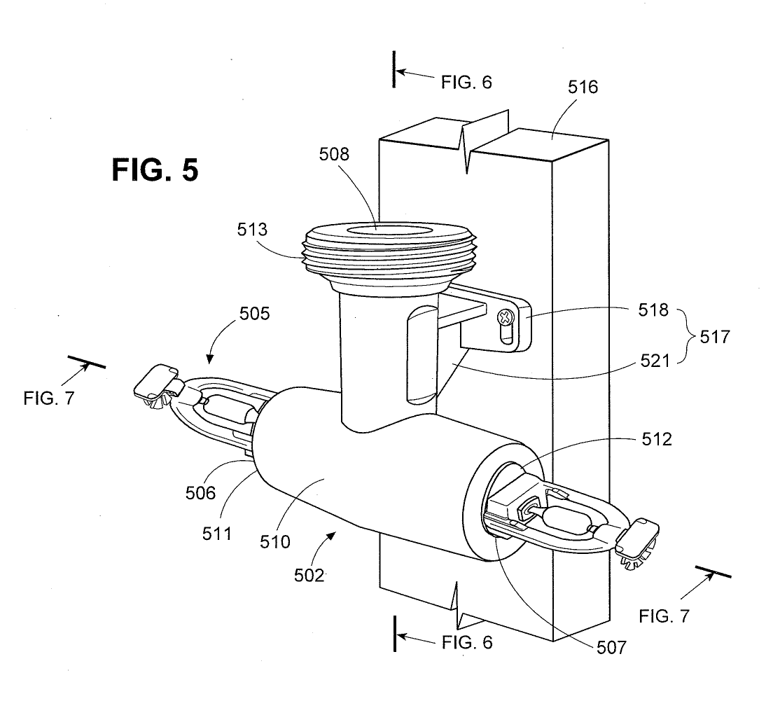

A third embodiment of a mountable fitting is shown in FIG. 5, shown configured as a mountable three port tee fitting 502. The fitting includes a generally hollow body 510 in fluid communication with three ports, 506, 507, and 508. The three ports 506-508 are coplanar and a first port 506 a second port 507 are coaxially opposed and substantially perpendicular to a third port 508. The three ports 506-508 are in fluid communication with each other through the body 510. The first port 506 and the second port 507 are fluidly connected to sprinklers 505, which are configured as horizontal sprinklers, while the third port is configured to fluidly connect to a fluid supply network 101, such as that shown in FIGS. 1, 2, 3 and 4.

Each of the three ports 506-508 has a respective connection portion 511-513. In one example, the first and second ports 506, 507 has a ½ inch NPT female threaded connections and the third port 508 has a nominal 1¾ inch male, unified fine threaded (UNF) connection portion. The male threads of the third connection portion 513 are configured to engage with mating female UNF threads of a compression nut (not shown), which is configured in the same fashion as the nut 113 described above and shown in FIGS. 1-4. Of course, in other embodiments, the ports 506-508 may be configured with other connection types and sizes. In an alternate embodiment, the three ports could also be configured more generically as a Y-fitting, with the three ports 506-508 extending at various angles with respect to one another.

The fitting 502 is configured to be mounted to the structure 116 in similar fashion to the first and second embodiments shown in FIGS. 1-4. In particular, the fitting includes a pedestal 517 comprised of an extension portion 521 and a mounting flange 518. The pedestal 517 extends substantially perpendicular to the body along the third port 508, which is shown as being oriented substantially vertically in FIG. 5. The mounting flange 518 extends substantially transverse to the third port 508. The extension portion 521 extends from the outer surface of the body to the mounting flange a predetermined distance.

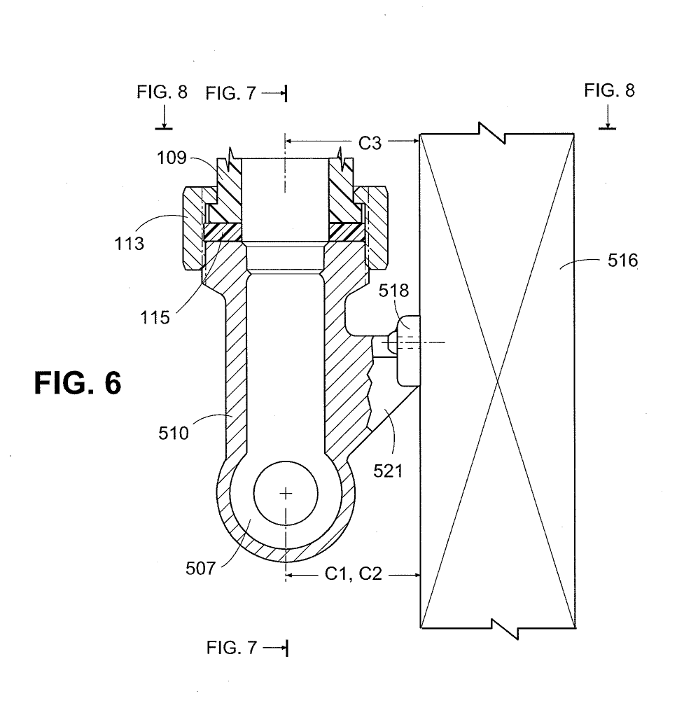

As shown in FIG. 6, the pedestal 518 is configured to space the body 510 of the fitting and the connection portions 511-513 corresponding to the ports 506-508 the predetermined distance. The predetermined distance, in one example, is chosen to provide sufficient clearance between at least one of the respective connection portions 511-513 to facilitate making a fluid connection to the respective ports 506-508. For example, as shown in FIG. 6, the pedestal 517 disposes the third connection portion 513 a distance C3 from the structure 116 such that the compression nut 113 can be rotated and threaded onto the third connection portion 513. Also, the pedestal 517 disposes the first and second connection portions, 511 and 512, respective distances C1, C2 from the structure such that a tool, such as, for example, a wrench can be used to turn the wrench boss of the respective sprinklers 505 fluidly coupled to the respective ports 506, 507.

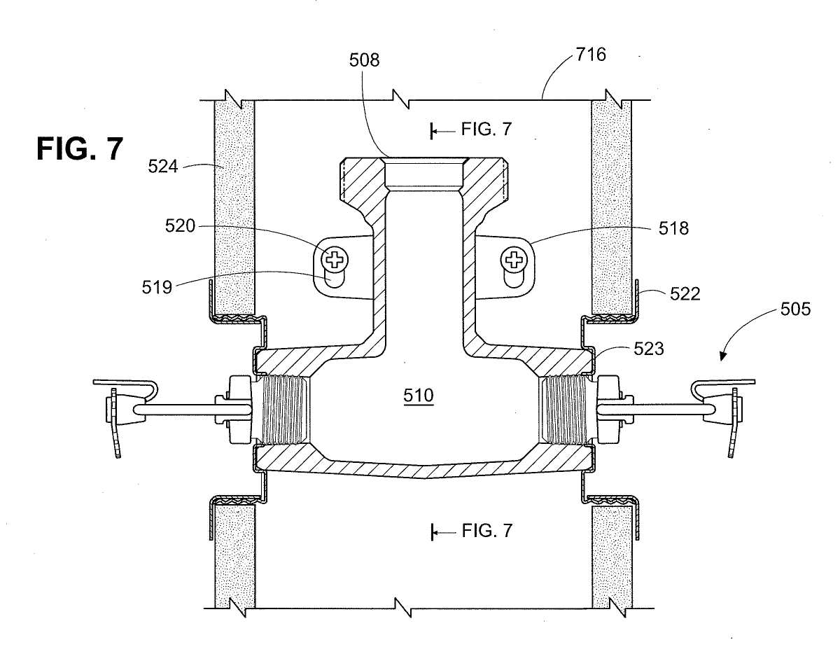

The mountable fitting shown in FIGS. 5 and 6 can be used, for example, to facilitate the installation of horizontal sidewall sprinklers 105 in adjoining rooms of a building, such as adjoining hotel rooms, using a single fluid conduit drop in the adjoining wall. For example, in one embodiment shown in FIG. 7, the tee fitting 502, coupled to sprinklers 105, is mounted to a vertical wall stud 516 that is positioned between two wall surfaces, such as wall surface of adjoining rooms. While not shown in FIG. 7, the third port can be connected to a piping network, such as the piping network 101 shown in FIG. 1.

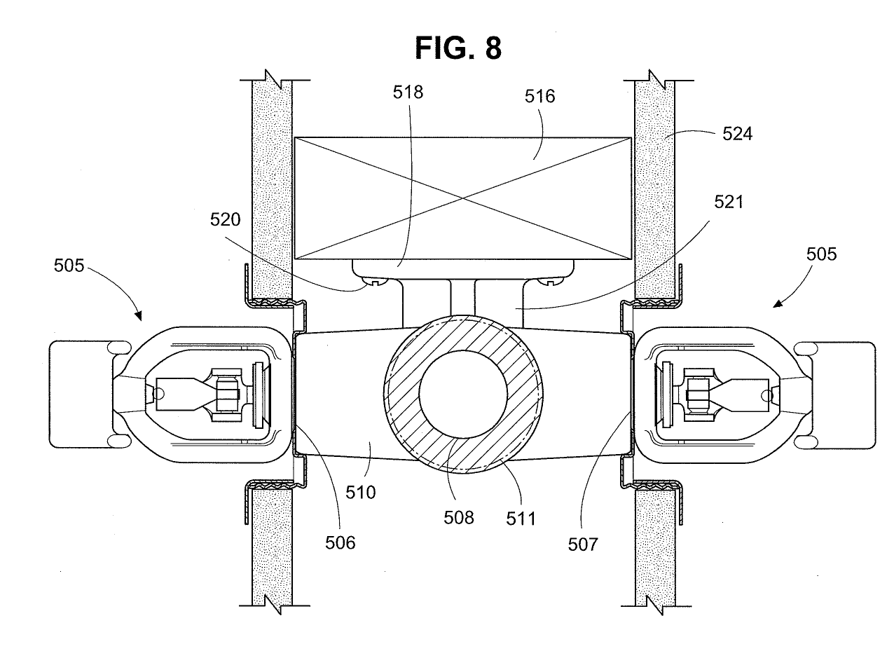

FIG. 8 shows a plan view of the fitting 502 mounted to the structure 516 between the walls 524. By virtue of this arrangement, a single fluid conduit and fitting 502 can be connected to two sprinklers, each servicing an adjacent room. Accordingly, the reduction in amount of conventional fittings 104 and fluid supply conduits 103 plumbed to complete the installation of sprinklers to a multiple room building, such as a hotel, school, office, or dormitory, can be significantly reduced along with a reduction in the cost of materials and labor.

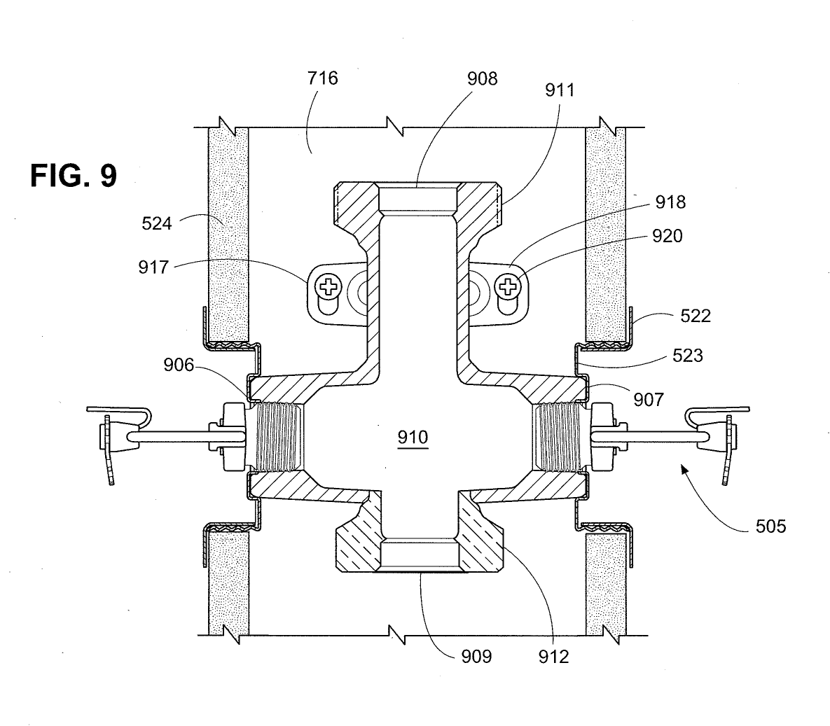

FIG. 9 shows yet another example of a mountable fitting in accordance with the disclosure having four ports, 906-909, in communication with a body 910, wherein the ports are arranged substantially perpendicular to each other in a cross pattern. The ports 906-908 are arranged in similar fashion to ports 506-508 of the three-port fitting 502, however a fourth port 909 is added in line with port 908. As shown in FIG. 9, the fitting 902 includes a pedestal 917 extending from the body 910 of the fitting 902. The fitting 902 is shown mounted to structure 716 between walls 524. Oppositely directed horizontal sidewall sprinklers 505 are fluidly connected to ports 906 and 907 to direct fluid away from the walls 524. By virtue of the fourth port 909, the fitting 902 can be connected to further fluid distribution elements, including, but not limited to, fluid conduits, fittings, and sprinklers. For example, where the port 908 is connected to a piping network fed by a fluid supply above the fitting 902 on an upper level of a building, such as piping network 101 (FIG. 1), port 909 can be connected to other fittings 902 on lower levels of the building via conduits 103 between the walls 524 and ceilings 124 of the building.

The various embodiments of mountable fittings discussed in the foregoing can be formed from suitable materials, such as metals, including brass and stainless steel. The fittings may be also be constructed of a suitable plastic materials, such as cross-linked polyethylene (PEX), PVC, and CPVC. The fittings are also configured to be compliant with Underwriter Laboratory Standards 11821 and 203 for fire protection service in residential applications using thermoplastic pipe fittings. Also, the fittings described above are configured to be certified with National Sanitation Foundation.

Moreover, the body 110, 510, 910 and pedestal 117, 517, 917 of the respective fittings 102, 502, and 902 described herein may be formed of different materials. For example, the bodies of the fittings may be formed from a plastic material, while the pedestal and connector portions may be made from different materials, which may be the same as the type of materials the fitting is connecting to. Alternatively, the body and the pedestal may both be formed of a plastic material. In one, the fitting is formed from brass. Moreover, while the mountable fitting is monolithic with the pedestal, it will be appreciated by one of skill in the art that in other embodiments of the mountable fitting, the body of the fitting may be configured to be operably attachable and detachable from the pedestal such, such as, for example, by snap fit connection, and the like.

The following discusses but a few of the advantages that result by virtue of the mountable fittings and system described herein. First, the mountable fittings can be mounted before the installation of any piping, so as to locate the path of the piping network. This locating feature allows the piping to be physically supported as it is simultaneously being fluidly connected to such mountable fluid connectors, eliminating conventional pipe hangers at the locations of the mountable fittings. Moreover, a sprinkler may be installed to the mountable fitting on a workbench prior to either the mountable fitting or the sprinkler being connected to the piping network. The mountable fitting/sprinkler subassembly can then be mounted to the building structure before or after the sprinkler network piping is installed. Installing the sprinkler/mountable fitting subassembly is advantageous for a number of reasons. First, it may be desirable or necessary to install sprinklers and associated fluid piping in locations where there is not sufficient space to use a tool to connect the sprinkler to the piping network, but there is sufficient space to mount the mountable fitting/sprinkler to the building structure. Secondly, mounting the mountable fitting/sprinkler subassembly is advantageous because the distance between the building structure and the finished wall surface are fixed and known prior to connecting the mountable fitting with respect to them, and so the fitting, sprinkler, and any extension pieces needed to adequately position the sprinkler relative to the finished wall, can be prefabricated and installed prior to the installation of the rest of the upstream sprinkler piping network. As a result, piping installers can work backwards, installing the system in a direction from the mounted fitting/sprinklers assemblies to the fluid supply piping, rather than plumbing the supply piping first and attempting to try to locate and precisely measure locations where sprinklers are intended to be located, and trying to estimate and provide sufficient space around any nearby building structure that might interfere with tools used for connecting the sprinkler to the supply piping. Such feature is especially advantageous where the piping is flexible or semi-rigid, such as cross-linked polyethylene (PEX) tubing, which conventionally can be cut to length, terminated with various fittings which can be connected to the connection portions of the ports of the mountable fittings. Accordingly, mounting the mountable fittings first, fixes the location of the sprinklers and the plumbing connecting to those fittings and helps ensure that the sprinklers are installed in locations which provide access for using tools or which provide sufficient access at least to mount the sprinkler and fitting assembly. Of course, the foregoing advantages are not meant as exhaustive or limiting the uses and benefits of the various aspects of the invention.

By virtue of the arrangements of the fitting 102 shown in FIGS. 1-9, installation of the sprinkler system piping network and sprinklers can be facilitated. For example, the fitting 102 and the piping connected thereto do not need to be supported at the location of the fitting 102 with a conventional pipe hanger, since the structural support can be provided by virtue of the mounting of the fitting 102 to the structure 116. Moreover, the sprinkler 105 can be connected to the fitting 105 as a sprinkler subassembly prior to mounting the fitting 102 to the structure 116. In addition, the fitting, sprinkler, and tailpiece may also be assembled as a subassembly and mounted to the structure 116 either before or after the rest of the piping network 101 is installed. Such further assembly can be done at a workbench rather than at ceiling height. Reducing the amount of labor needed to install sprinklers while working at ceiling height may reduce installation time and improve ergonomics.

1. A fluid distribution system including:
a fluid supply;
at least one conduit in fluid communication with the fluid supply; and
at least one mountable fitting fluidly coupled to the conduit, wherein the mountable fitting includes:
a body defining a cavity having a plurality of ports in fluid communication with the cavity and the conduit, at least one port of the plurality of ports having a connection portion configured to fluidly couple to at least the fluid conduit, and
a mounting base extending a fixed distance from the body and configured to be mounted to a structure to space the body a fixed distance from the structure.

2. The fluid distribution system according to claim 1, wherein, in the mounting base of the mountable fluid connector is configured to be at least one of monolithic with the body and operably attachable and detachable from the body.

3. The fluid distribution system according to claim 1, wherein at least another of the plurality of ports is configured to be fluidly coupled to a fire protection sprinkler.

4. The fluid distribution system according to claim 1, wherein the mountable fitting is formed from at least one of brass, acetyl copolymer, stainless steel, copper, iron, CPVC, and nylon.

5. The fluid distribution system according to claim 1, wherein the fixed distance between the structure and the body is configured at least to provide clearance for the application of a tool to fluidly couple the mountable fitting to the conduit.

6. The fluid distribution system according to claim 1, wherein the conduit includes at least one of rigid tubing, semi-rigid tubing, and flexible tubing.

7. The fluid distribution system according to claim 1, wherein the conduit includes at least one of PEX tubing, CPVC, PTFE, copper, and stainless steel.

8. The fluid distribution system according to claim 1, wherein the body has a first port, a second port, and a third port, the first, second, and third ports being coplanar with each other.

9. The fluid distribution system according to claim 8, wherein the first port, second port, and third port are configured as at least one of a tee fitting and a Y-fitting.

10. The fluid distribution system according to claim 9, wherein the first and second ports are configured to be fluidly coupled to a fire protection sprinkler.

11. The fluid distribution system according to claim 8, wherein the body includes a fourth port coplanar with the first, second, and third ports, wherein the first, second, third, and fourth ports are configured as a cross fitting.

12. The fluid distribution system according to claim 1, wherein the connection portion of the at least one port is configured as at least one of a hose barb, a threaded connector, a Pipe Master™ tailpiece, a connector to couple to a Pipe Master™ tailpiece, a sanitary fitting, and a compression fitting.

13. The fluid distribution system according to claim 1, wherein the connection portion of the at least one port is configured to fluidly couple with a Pipe Master™ tailpiece connected to the conduit.

14. The fluid distribution system according to claim 1, wherein the mounting base includes an extension portion extending from an outer surface of the body the fixed distance and a mounting flange portion extending substantially transverse from the extension portion another fixed distance.

15. The fluid distribution system according to claim 14, wherein the flange extends substantially transverse to the at least one port.

16. The fluid distribution system according to claim 1, wherein the base includes at least one aperture formed therein configured to receive a fastener therethrough.

17. The fluid distribution system according to claim 1, wherein the aperture is configured as an elongated slot.

18. The fluid distribution system according to claim 1, wherein the nominal size of each of the plurality of ports includes at least one of ½″, ¾″, 1″, 1¼″, 1½″, and 1¾″.

19. A fitting comprising:
a body defining a cavity having a plurality of ports in fluid communication with the cavity, at least one port of the plurality of ports having a connection portion configured to fluidly couple to at least a conduit, and
a mounting base extending a fixed distance from the body configured to be mounted to a structure to space the body a fixed distance from the structure.

20. The fitting according to claim 19, wherein the mounting base is configured to be at least one of monolithic with the body and operably attachable and detachable from the body.

21. The fitting according to claim 19, wherein at least another of the plurality of ports is configured to be fluidly coupled to a fire protection sprinkler.

22. The fitting according to claim 19, wherein the mountable fitting is formed from at least one of brass, acetyl copolymer, stainless steel, copper, iron, CPVC, and nylon.

23. The fitting according to claim 19, wherein the fixed distance between the structure and the body is configured at least to provide clearance for the application of a tool to fluidly couple the fitting to the conduit.

24. The fitting according to claim 19, wherein the body has a first port, a second port, and a third port, the first, second, and third ports being coplanar with each other.

25. The fitting according to claim 19, wherein the first port, second port, and third port are configured as at least one of a tee fitting and a Y-fitting.

26. The fitting according to claim 25, wherein the first and second ports are configured to be fluidly coupled to at least one of a fire protection sprinkler, another fitting, and a conduit.

27. The fitting according to claim 24, wherein the body includes a fourth port coplanar with the first, second, and third ports, wherein the first, second, third, and fourth ports are configured as a cross fitting.

28. The fitting according to claim 19, wherein the connection portion of the at least one port is configured as at least one of a hose barb, a threaded connector, a Pipe Master™ tailpiece, a connector to couple to a Pipe Master™ tailpiece, a sanitary fitting, and a compression fitting.

29. The fitting according to claim 19, wherein the connection portion of the at least one port is configured to be fluidly coupled to a Pipe Master™ tailpiece connected to the conduit.

30. The fitting according to claim 19, wherein the mounting base includes an extension portion extending from an outer surface of the body the fixed distance and a mounting flange portion extending substantially transverse from the extension portion another fixed distance.

31. The fitting according to claim 30, wherein the mounting flange extends substantially transverse to the at least one port.

32. The fitting according to claim 31, wherein the mounting flange includes at least one aperture formed therein configured to receive a fastener therethrough.

33. The fitting according to claim 32, wherein the aperture is configured as an elongated slot.

34. The fitting according to claim 19, wherein the nominal size of each of the plurality of ports includes at least one of ½″, ¾″, 1″, 1¼″, 1½″, and 1¾″.

35. A mountable fitting assembly comprising:
a fitting including
a body defining a cavity having a plurality of ports in fluid communication with the cavity, at least one port of the plurality of ports having a connection portion configured to fluidly couple to at least a conduit, and
a mounting base extending a fixed distance from the body configured to be mounted to a structure to space the body a fixed distance from the structure; and
at least one fluid distribution element fluidly coupled to at least one other of the plurality of ports, wherein the assembly is configured to be fluidly coupled to the conduit together as a single assembly.

36. The mountable fitting assembly according to claim 35, wherein the fluid distribution element includes at least one of a sprinkler and a fluid fitting.

37. The mountable fitting assembly according to claim 36, wherein the fluid fitting includes at least one of a pipe coupling and a Pipe Master™ tailpiece.

38. A method of using a fluid connector, comprising:
providing a fluid connector, wherein the fluid connector includes a body defining a cavity having a plurality of ports in fluid communication with the cavity, at least one port of the plurality of ports having a connection portion configured to fluidly couple to at least a conduit, and a mounting base extending a fixed distance from the body configured to be mounted to a structure to space the body a fixed distance from the structure;
positioning the fluid connector on a structure; and
securing, at the mounting base, the fluid connector to the structure.

39. The method according to claim 38, further comprising fluidly coupling at least one of a fluid conduit, fluid connector, and sprinkler to the at least one port of the plurality of ports.
